(19) United States
(12) Patent Application Publication
(10) Pub. No.: US 2026/0175639 A1
(43) Pub. Date: Jun. 25, 2026

(54) AIR CONDITIONING CONTROL SYSTEM OF A TOWED VEHICLE AND METHOD THEREFOR

(71) Applicants: HYUNDAI MOTOR COMPANY, SEOUL (KR); KIA CORPORATION, SEOUL (KR)

(72) Inventor: Se Jun Park, Hwaseong-si (KR)

(73) Assignees: HYUNDAI MOTOR COMPANY, SEOUL (KR); KIA CORPORATION, SEOUL (KR)

(21) Appl. No.: 19/261,673

(22) Filed: Jul. 7, 2025

(30) Foreign Application Priority Data
Dec. 23, 2024 (KR) 10-2024-0193494

(51) Int. Cl. B60H 1/00

(52) U.S. Cl. CPC B60H 1/00735

(57) ABSTRACT

An air conditioning control system of a towed vehicle includes an input device of a towing vehicle configured to input a control intention of an air conditioning system of the towed vehicle and an interior setting temperature of the towed vehicle. The system also includes: a first vehicle controller of the towing vehicle configured to transmit a control signal for operating the air conditioning system of the towed vehicle to the towed vehicle based on the control intention input via the input device; a second vehicle controller of the towed vehicle configured to be communicably connected to the first vehicle controller and receive the control signal transmitted from the first vehicle controller; and an air conditioning controller of the towed vehicle configured to control the operation of the air conditioning system of the towed vehicle based on the control signal received by the second vehicle controller.

### CROSS-REFERENCE TO RELATED APPLICATION

This application claims, under 35 U.S.C. § 119(a), the benefit of and priority to Korean Patent Application No. 10-2024-0193494 filed on Dec. 23, 2024, the entire contents of which are incorporated herein by reference.

### BACKGROUND

### (a) Technical Field

The present disclosure relates to an air conditioning control system of a towed vehicle and a method therefor. More specifically, the present disclosure relates to an air conditioning control system of a towed vehicle and a method therefor capable of controlling the air conditioning system of the towed vehicle to keep the interior of the towed vehicle comfortable.

### (b) Background Art

When a user wants to use two vehicles at a desired destination, the user may use a towing function to bring two vehicles to the desired destination.

For example, one vehicle may serve as a towing vehicle for actual driving, and the other vehicle may serve as a towed vehicle connected to the rear of the towing vehicle by a towing device. As a result, the two vehicles can be brought to the desired destination.

However, after the towing vehicle and the towed vehicle move together to the destination using a flat tow mode (towing mode in which all four wheels of the towed vehicle are in contact with the ground) in extremely hot or cold conditions, the interior temperature and humidity of the towed vehicle are in a non-optimized state, which may cause inconvenience to the passenger getting into the towed vehicle.

More specifically, after the towing vehicle and the towed vehicle move together to the destination in extremely hot or cold conditions, the interior temperature and humidity of the towed vehicle may be excessively high in the extremely hot conditions or may be excessively low in the extremely cold conditions. As a result, the passenger's ride comfort in the towed vehicle may be significantly reduced, which may cause inconvenience to the passenger.

Moreover, in an extremely cold weather, frost occurs on a windshield glass of the towed vehicle due to a difference between a vehicle interior temperature and a vehicle outdoor temperature and a difference between a vehicle interior humidity and a vehicle outdoor humidity, which may increase the inconvenience of the passenger in the towed vehicle.

The information disclosed in this Background section is only to enhance understanding of the background of the disclosure. Therefore, the Background section may contain information that does not form the prior art that is already known in this country to a person of ordinary skill in the art.

### SUMMARY

The present disclosure has been made in an effort to solve the above-described problems associated with the prior art, and an object of the present disclosure is to provide an air conditioning control system of a towed vehicle capable of allowing, when a towing vehicle tows a towed vehicle to a destination, a second vehicle controller and an air conditioning controller of the towed vehicle to control an air conditioning system of the towed vehicle via the control of a first vehicle controller of the towing vehicle. As a result, the configuration makes it possible to keep the interior of the towed vehicle in a comfortable state, and a method therefor.

In one aspect, the present disclosure provides an air conditioning control system of a towed vehicle. The system includes: an input device of a towing vehicle configured to input a control intention of an air conditioning system of the towed vehicle and an interior setting temperature of the towed vehicle; and a first vehicle controller of the towing vehicle configured to transmit a control signal for operating the air conditioning system of the towed vehicle to the towed vehicle based on the control intention input via the input device. The system also includes a second vehicle controller of the towed vehicle configured to be communicably connected to the first vehicle controller and receive the control signal transmitted from the first vehicle controller. Additionally the system includes an air conditioning controller of the towed vehicle configured to control the operation of the air conditioning system of the towed vehicle based on the control signal received by the second vehicle controller.

In an example embodiment, the first vehicle controller may transmit an interior air recirculation mode command signal included in the control signal for operating the air conditioning system to the air conditioning controller via the second vehicle controller before the towed vehicle starts traveling.

In another example embodiment, the input device may include a user interface provided in the towed vehicle and a navigation device configured to output a destination input window of the towed vehicle when the control intention is input via the user interface.

In still another example embodiment, the navigation device may output, when a first specific time remains to reach a destination input via the destination input window while the towed vehicle is traveling, an air conditioning system operation request signal for the towed vehicle to the first vehicle controller.

In yet another example embodiment, the first vehicle controller may transmit a cooling or heating operation signal for the air conditioning system to the air conditioning controller via the second vehicle controller based on the air conditioning system operation request signal output from the navigation device. Additionally, the first vehicle controller may transmit an outdoor air recirculation mode command signal to the air conditioning controller via the second vehicle controller when a signal indicating that a second specific time, which is shorter than the first specific time, remains to reach the destination is received from the navigation device during a heating operation of the air conditioning system.

In another aspect, the present disclosure provides an air conditioning control method for a towed vehicle. The method includes: inputting a control intention of an air conditioning system of the towed vehicle and an interior setting temperature of the towed vehicle via an input device of a towing vehicle; and transmitting a control signal for operating the air conditioning system of the towed vehicle from a first vehicle controller of the towing vehicle to a second vehicle controller of the towed vehicle based on the control intention input via the input device. The method may also include controlling the air conditioning system of the towed vehicle by an air conditioning controller of the towed vehicle based on the control signal received by the second vehicle controller.

In an example embodiment, an interior air recirculation mode command signal included in the control signal for operating the air conditioning system may be transmitted to the air conditioning controller via the second vehicle controller from the first vehicle controller before the towed vehicle starts traveling. Additionally, an intake door in the air conditioning system of the towed vehicle may be switched to an interior air recirculation mode via the control of the air conditioning controller.

In another example embodiment, the method may further include outputting, when the control intention is input via the input device, a destination input window of the towed vehicle on a navigation device; and outputting, when a first specific time remains to reach a destination input to the destination input window, an air conditioning system operation request signal for the towed vehicle from the navigation device to the first vehicle controller. Additionally, the method may include transmitting a cooling or heating operation signal for the air conditioning system to the air conditioning controller via the second vehicle controller from the first vehicle controller based on the air conditioning system operation request signal output from the navigation device.

In still another example embodiment, the air conditioning system of the towed vehicle may be operated for interior cooling or heating by FATC (Full Automatic Temperature Control) of the air conditioning controller.

In yet another example embodiment, the method may further include transmitting an outdoor air recirculation mode command signal to the air conditioning controller via the second vehicle controller when the first vehicle controller receives a signal indicating that a second specific time, which is shorter than the first specific time, remains to reach the destination from the navigation device. The method may further include switching an intake door in the air conditioning system of the towed vehicle to an interior air recirculation mode via the control of the air conditioning controller.

In still yet another example embodiment, the first specific time may increase as a difference between the interior setting temperature and a current interior temperature of the towed vehicle increases. The second specific time may be determined based on an increase or decrease rate of the first specific time.

In still another aspect, the present disclosure provides an air conditioning control system of a towed vehicle. The system includes an input device of the towed vehicle configured to input a control intention of an air conditioning system of the towed vehicle and an interior setting temperature of the towed vehicle, in a flat tow mode. The system further includes a second vehicle controller of the towed vehicle configured to transmit a control signal for operating the air conditioning system of the towed vehicle to an air conditioning controller of the towed vehicle based on the control intention input via the input device. The system further includes the air conditioning controller of the towed vehicle configured to control the operation of the air conditioning system of the towed vehicle based on the control signal received by the second vehicle controller. The second vehicle controller transmits an interior air recirculation mode command signal included in the control signal for operating the air conditioning system to the air conditioning controller before the towed vehicle starts traveling.

In an example embodiment, the input device may include a user interface provided in the towed vehicle and a navigation device configured to output a destination input window of the towed vehicle when the control intention is input via the user interface.

In another example embodiment, the navigation device may output, when a first specific time remains to reach a destination input via the destination input window while the towed vehicle is towed by the towing vehicle, an air conditioning system operation request signal for the towed vehicle to the second vehicle controller.

In still another example embodiment, the second vehicle controller may transmit a cooling or heating operation signal for the air conditioning system to the air conditioning controller based on the air conditioning system operation request signal output from the navigation device. Additionally, the second vehicle controller may transmit an outdoor air recirculation mode command signal to the air conditioning controller when a signal indicating that a second specific time, which is shorter than the first specific time, remains to reach the destination is received from the navigation device during the heating operation of the air conditioning system.

In a further aspect, the present disclosure provides an air conditioning control method for a towed vehicle. The method includes inputting a control intention of an air conditioning system of the towed vehicle and an interior setting temperature of the towed vehicle via an input device of the towed vehicle. The method further includes transmitting a control signal for operating the air conditioning system of the towed vehicle to an air conditioning controller of the towed vehicle based on the control intention input via the input device. The method may further include controlling the air conditioning system of the towed vehicle by the air conditioning controller of the towed vehicle based on the control signal received from a second vehicle controller. An interior air recirculation mode command signal included in the control signal for operating the air conditioning system is transmitted to the air conditioning controller from the second vehicle controller before the towed vehicle starts traveling. An intake door in the air conditioning system of the towed vehicle is switched to an interior air recirculation mode via the control of the air conditioning controller.

In an example embodiment, the method may further include outputting, when the control intention is input via the input device of the towed vehicle, a destination input window of the towed vehicle on a navigation device. The method further includes outputting, when a first specific time remains to reach a destination input to the destination input window, an air conditioning system operation request signal for the towed vehicle from the navigation device to the second vehicle controller. The method further includes transmitting a cooling or heating operation signal for the air conditioning system to the air conditioning controller from the second vehicle controller based on the air conditioning system operation request signal output from the navigation device.

In another example embodiment, the air conditioning system of the towed vehicle may be operated for interior cooling or heating by FATC (Full Automatic Temperature Control) of the air conditioning controller.

In still another example embodiment, the method may further include transmitting, while the heating operation of the air conditioning system is performed, an outdoor air recirculation mode command signal to the air conditioning controller when the second vehicle controller receives a signal indicating that a second specific time, which is shorter than the first specific time, remains to reach the destination from the navigation device. The method may further include switching the intake door in the air conditioning system of the towed vehicle to an outdoor air recirculation mode via the control of the air conditioning controller.

In yet another example embodiment, the first specific time may increase as a difference between the interior setting temperature and a current interior temperature of the towed vehicle increases. The second specific time may be determined based on an increase or decrease rate of the first specific time.

Other aspects and example embodiments of the disclosure are discussed below.

### BRIEF DESCRIPTION OF THE DRAWINGS

The above and other features of the present disclosure are now described in detail with reference to certain example embodiments thereof illustrated the accompanying drawings which are given hereinafter by way of illustration only, and thus are not limitative of the present disclosure, and wherein:

FIG. 1 is a control configuration diagram showing an air conditioning control system of a towed vehicle according to an embodiment of the present disclosure;

FIG. 2 is a flowchart showing an air conditioning control method for a towed vehicle according to an embodiment of the present disclosure;

FIG. 3 is a control configuration diagram showing an air conditioning control system of a towed vehicle according to another embodiment of the present disclosure; and

FIG. 4 is a flowchart showing an air conditioning control method for a towed vehicle according to another embodiment of the present disclosure.

It should be understood that the appended drawings are not necessarily to scale, presenting a somewhat simplified representation of various example features illustrative of the basic principles of the disclosure. The specific design features of the present disclosure as disclosed herein, including, for example, specific dimensions, orientations, locations, and shapes are determined in part by the particular intended application and use environment.

In the figures, reference numbers refer to the same or equivalent parts of the present disclosure throughout the several figures of the drawing.

### DETAILED DESCRIPTION

Specific structural or functional descriptions presented in the embodiments of the present disclosure are merely exemplified for the purpose of describing embodiments according to the concept of the present disclosure, and embodiments according to the concept of the present disclosure may be implemented in various forms. Furthermore, the present disclosure should not be construed as limited to the embodiments described in this specification, but should be understood to include all modifications, equivalents, or substitutes included in the concept and technical scope of the present disclosure.

It should be understood that, although the terms “first”, “second”, and the like may be used herein to describe various elements, these elements should not be limited by these terms. These terms are only used to distinguish one element from another. For example, a first element may be termed a second element, and, similarly, a second element may be termed a first element, without departing from the scope of the example embodiments of the present disclosure.

In addition, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (e.g., “between” and “directly between”, “adjacent” and “directly adjacent”, and the like).

Wherever possible, the same reference numbers are used throughout the drawings to refer to the same or like parts. The terminology used herein is for the purpose of describing particular embodiments only and is not intended to limit example embodiments of the disclosure. As used herein, the singular forms “a”, “an”, and “the” are intended to include the plural forms as well, unless the context clearly indicates otherwise. It should be further understood that the terms “comprise”, “include”, and “have” used herein specify the presence of stated components, steps, operations, and/or elements, but do not preclude the presence or addition of one or more other components, steps, operations, and/or elements.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, example embodiments of the present disclosure are described in detail with reference to the accompanying drawings.

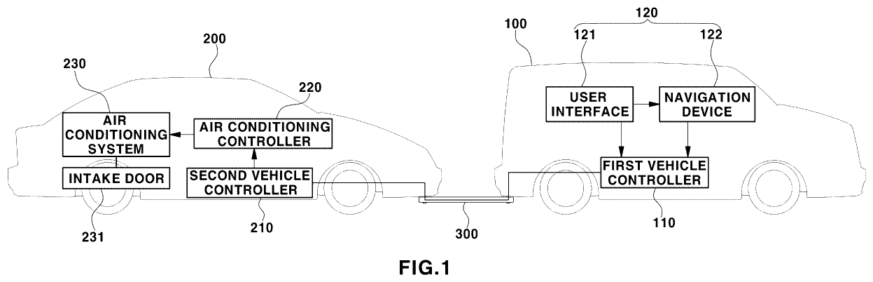

FIG. 1 is a control configuration diagram showing an air conditioning control system of a towed vehicle according to an embodiment of the present disclosure.

As shown in FIG. 1, the air conditioning control system of the towed vehicle according to the embodiment of the present disclosure includes an input device 120 and a first vehicle controller 110 mounted in a towing vehicle 100, and a second vehicle controller 210, an air conditioning controller 220, and an air conditioning system 230 mounted in a towed vehicle 200.

The input device 120 is provided for a user to input a control intention of the air conditioning system 230 of the towed vehicle 200 and an interior setting temperature of the towed vehicle 200 under the condition that the towing vehicle is towing the towed vehicle to a destination in a flat tow mode, and may include a user interface 121 and a navigation device 122 provided in the towing vehicle 100.

The user interface 121 may include a touch input display, a switch, a trackball, a joystick, or the like. The user may input the control intention for the air conditioning system 230 of the towed vehicle 200 and the interior setting temperature of the towed vehicle 200 through the user interface 121.

For example, the user may select a control intention (e.g., Yes) for the air conditioning system 230 of the towed vehicle 200 through USM (User Setting Mode) in a menu displayed on a display provided in the towing vehicle, and may input the interior setting temperature of the towed vehicle 200 therethrough.

The navigation device 122 outputs a modal dialog in the form of a vehicle destination input window when the control intention for the air conditioning system 230 of the towed vehicle 200 is input through (e.g., via) the user interface 121.

The first vehicle controller 110 of the towing vehicle 100 transmits, when the control intention for the air conditioning system 230 is input through the user interface 121 of the input device 120, a control signal for operating the air conditioning system 230 of the towed vehicle 200 to the second vehicle controller 210 of the towed vehicle 200.

To this end, the first vehicle controller 110 of the towing vehicle 100 and the second vehicle controller 210 of the towed vehicle 200 each have a communication module (e.g., a CAN communication module). Accordingly, the first vehicle controller 110 and the second vehicle controller 210 may be communicably connected to each other.

For example, the towing vehicle 100 and the towed vehicle 200 may be communicably connected to each other by a connector 300 including a communication cable, so that the first vehicle controller 110 and the second vehicle controller 210 may be communicably connected to each other through the connector 300.

The second vehicle controller 210 of the towed vehicle 200 receives the control signal for operating the air conditioning system 230, transmitted from the first vehicle controller 110, and transmits the received signal to the air conditioning controller 220, which is a sub-controller.

The air conditioning controller 220 controls the operation of the air conditioning system 230 of the towed vehicle 200 based on the control signal for operating the air conditioning system 230 received through the second vehicle controller 210.

Thus, based on the control signal for operating the air conditioning system 230 transmitted from the first vehicle controller 110, the air conditioning controller 220 controls an interior air recirculation mode or an outdoor air recirculation mode of the air conditioning system 230, or controls a cooling or heating operation of the air conditioning system 230.

On the other hand, the first vehicle controller 110 transmits an interior air recirculation mode command signal included in the control signal for operating the air conditioning system to the air conditioning controller 220 through the second vehicle controller 210 before the towed vehicle starts traveling.

For example, when it is determined that the control intention for the air conditioning system 230 is input through the user interface 121 of the input device 120, the first vehicle controller 110 transmits the interior air recirculation mode command signal to the air conditioning controller 220 through the second vehicle controller 210 before the towed vehicle 200 starts traveling.

Thus, an intake door 231 in the air conditioning system 230 is switched to an interior air recirculation position (e.g., mode) for blocking outside (e.g., exterior) air under the control of the air conditioning controller 220. Thus, it is possible to prevent exhaust gases, in the case of an internal combustion engine towing vehicle, from entering the interior of the towed vehicle. Additionally, it is possible to minimize energy consumption of an electric compressor that drives the air conditioning system using the interior air recirculation mode when the air conditioning system of the towed vehicle is operated before arriving at the destination.

The navigation device 122 outputs, when a predetermined first specific time is left (e.g., remains) to reach a destination input through the destination input window while the towed vehicle is traveling, an air conditioning system operation request signal for the towed vehicle to the first vehicle controller 110.

In addition, the first vehicle controller 110 transmits a cooling or heating operation signal for the air conditioning system 230 to the air conditioning controller 220 through the second vehicle controller 210 based on the air conditioning system operation request signal output from the navigation device 122.

Thus, the air conditioning controller 220 controls the cooling or heating operation of the air conditioning system 230 based on the cooling or heating operation signal for the air conditioning system 230 transmitted from the first vehicle controller 110.

For example, the air conditioning system 230 of the towed vehicle 200 is operated for interior cooling or heating by FATC (Full Automatic Temperature Control) of the air conditioning controller, so that the interior temperature and humidity of the towed vehicle can be adjusted to a comfortable condition.

Further, the first vehicle controller 110 transmits an outdoor air recirculation mode command signal to the air conditioning controller 220 through the second vehicle controller 210 when a signal indicating that a second specific time, which is shorter than the first specific time, is left to reach the destination is received from the navigation device 122 during the heating operation of the air conditioning system 230.

The transmission of the outdoor air recirculation mode command signal from the first vehicle controller 110 to the air conditioning controller 220 is performed to prevent frost or moisture from accumulating on a windshield glass of the towed vehicle due to a difference between a vehicle interior temperature and a vehicle outdoor temperature.

Thus, the intake door 231 of the air conditioning system 230 is switched to an outdoor air recirculation position for drawing in outdoor air under the control of the air conditioning controller 220, so that the outdoor air may be introduced into the towed vehicle. As a result, easily removing the frost or moisture accumulated on the windshield glass of the towed vehicle by the outdoor air flowing in the interior before arriving at the destination may be performed.

Hereinafter, an air conditioning system control method of a towed vehicle according to an embodiment of the present disclosure is described.

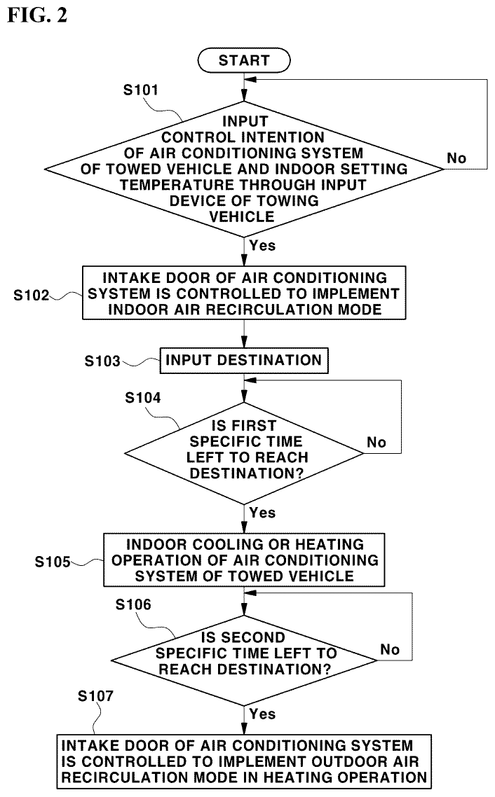

FIG. 2 is a flowchart showing an air conditioning system control method of a towed vehicle according to an embodiment of the present disclosure.

First, it is determined whether a control intension of the air conditioning system of the towed vehicle 200 and an interior setting temperature of the towed vehicle 200 are input through the input device 120 of the towing vehicle 100, by the first vehicle controller 110 of the towing vehicle 100 (S101).

For example, when a user selects the control intention (e.g., Yes) for the air conditioning system 230 of the towed vehicle 200 through the USM (User Setting Mode) in the display menu of the user interface 121 provided in the towing vehicle, and inputs the interior setting temperature of the towed vehicle 200, the first vehicle controller 110 may determine that the air conditioning system control intention and the interior setting temperature of the towed vehicle 200 are input.

Thus, based on the control intention for the air conditioning system 230 of the towed vehicle 200 input through the user interface 121 of the input device 120, a control signal for operating the air conditioning system of the towed vehicle may be transmitted from the first vehicle controller 110 of the towing vehicle to the air conditioning controller 220, which is a sub-controller, through the second vehicle controller 210 of the towed vehicle 200. The air conditioning system 230 of the towed vehicle 200 may be operated under the control of the air conditioning controller 220.

Then, an intake door 231 of the air conditioning system 230 is controlled to implement an interior air recirculation mode under the control of the air conditioning controller 220 of the towed vehicle 200 (S102).

To this end, when it is determined that the control intention for the air conditioning system 230 is input through the user interface 121 of the input device 120, the first vehicle controller 110 transmits an interior air recirculation mode command signal to the air conditioning controller 220 through the second vehicle controller 210 before the towed vehicle starts traveling.

Thus, an air intake door 231 in the air conditioning system 230 is switched to the interior air recirculation position for blocking outdoor air under the control of the air conditioning controller 220. Thus, it is possible to prevent exhaust gases, in the case of an internal combustion engine towing vehicle, from entering the interior of the towed vehicle, and to minimize energy consumption of an electric compressor that drives the air conditioning system using the interior air recirculation mode when the air conditioning system of the towed vehicle is operated before arriving at the destination.

Then, when the control intention for the air conditioning system 230 of the towed vehicle 200 is input through the user interface 121 of the input device 120, the destination input window of the towed vehicle is displayed as a modal dialog on the navigation device 122, so that a destination of the towed vehicle may be input (S103).

Specifically, when the control intention signal for the air conditioning system 230 of the towed vehicle 200 input through the user interface 121 of the input device 120 is transmitted to the navigation device 122, the navigation device 122 automatically outputs a modal dialog in the form of the towed vehicle destination input window, thereby allowing the user to input the towed vehicle's destination.

Then, it is determined whether a predetermined first specific time is left to reach the destination input through the destination input window during traveling, through the navigation device 122 (S104).

As a result of the determination in step S104, when it is determined that the first specific time is left to reach the destination of the towed vehicle, an operation request signal for the air conditioning system of the towed vehicle is output from the navigation device 122 to the first vehicle controller 110.

The first specific time may be determined to increase proportionally as a difference between the interior setting temperature and the current interior temperature of the towed vehicle increases. Alternatively, the first specific time may be determined to decrease proportionally as the difference between the interior setting temperature and the current interior temperature of the towed vehicle decreases.

Subsequently, based on the air conditioning system operation request signal output from the navigation device 122, the second vehicle controller 210 transmits a cooling or heating operation signal for the air conditioning system 230 to the air conditioning controller 220 from the first vehicle controller 110.

For example, depending on an outdoor temperature detected by a temperature sensor of the towed vehicle, the cooling operation signal for the air conditioning system may be transmitted in extremely hot weather, and the heating operation signal for the air conditioning system may be transmitted in extremely cold weather.

Accordingly, based on the cooling or heating operation signal for the air conditioning system 230 transmitted from the first vehicle controller 110, the air conditioning controller 220 performs control for operating the air conditioning system 230 in the interior cooling or interior heating mode. As a result, the air conditioning controller 220 performs the interior cooling or interior heating operation of the air conditioning system 230 of the towed vehicle (S105).

For example, the air conditioning system 230 of the towed vehicle 200 is operated for interior cooling or heating by FATC (Full Automatic Temperature Control) of the air conditioning controller 220, so that the interior temperature and humidity of the towed vehicle can be adjusted to a comfortable condition.

In this way, when the towing vehicle 100 tows the towed vehicle 200 to the destination, the air conditioning system 230 of the towed vehicle 200 is controlled to optimize the interior temperature and humidity of the towed vehicle 200 before reaching the destination, thereby making it possible to keep the interior of the towed vehicle 200 comfortable and improve the convenience of passengers entering the towed vehicle 200 after arriving at the destination.

Then, during the heating operation of the air conditioning system 230, it is determined whether the second specific time, which is shorter than the first specific time, is left to reach the destination through the navigation device 122 (S106).

When a signal indicating that the second specific time is left, which is shorter than the first specific time, to reach the destination, is received from the navigation device 122, the first vehicle controller 110 transmits an outdoor air recirculation mode command signal to the air conditioning controller 220 through the second vehicle controller 210.

The second specific time may be determined based on an increase or decrease rate of the first specific time. For example, the second specific time may increase proportionally as the first specific time increases, and may decrease proportionally as the first specific time decreases.

Accordingly, the intake door 231 of the air conditioning system 230 is switched to the outdoor air recirculation position for drawing in outdoor air under the control of the air conditioning controller 220 (S107).

Preferably, in step S107, since it is unnecessary to switch the intake door to the outdoor air recirculation position due to a dehumidification effect during cooling, the intake door is switched to the outdoor air recirculation position during heating.

As described above, when the second specific time, which is shorter than the first specific time, is left to reach the destination, the intake door of the air conditioning system 230 of the towed vehicle 200 is switched to the outdoor air recirculation position before arriving at the destination, so that the outdoor air may be introduced into the towed vehicle 200. As a result, easily removing the frost or moisture accumulated on the windshield glass of the towed vehicle 200 by the outdoor air flowing in the interior of the towed vehicle 200 before arriving at the destination may be performed.

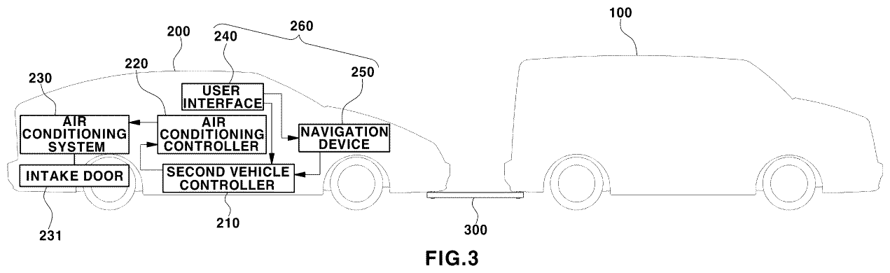

FIG. 3 is a control configuration diagram showing an air conditioning control system of a towed vehicle according to another embodiment of the present disclosure.

The air conditioning control system of the towed vehicle according to the present embodiment is characterized in that the air conditioning system of the towed vehicle is not controlled by the first vehicle controller of the towing vehicle, but is controlled by the second vehicle controller of the towed vehicle, in the flat tow mode.

To this end, the air conditioning control system of the towed vehicle according to the present embodiment includes an input device 260, the second vehicle controller 210, the air conditioning controller 220, and the air conditioning system 230 mounted in the towed vehicle 200, as shown in FIG. 3.

The towed vehicle 200 may be connected to the towing vehicle 100 through the connector 300 in the flat tow mode.

The input device 260 is provided for a user to input a control intention for the air conditioning system 230 of the towed vehicle 200 and an interior setting temperature of the towed vehicle 200 under the condition that the towing vehicle 100 is towing the towed vehicle 200 to a destination in the flat tow mode. The input device 260 may include a user interface 240 and a navigation device 250 provided in the towed vehicle 200.

The user interface 240 may include a touch input display, a switch, a trackball, a joystick, or the like, and the user may input the control intention for the air conditioning system 230 of the towed vehicle 200 and the interior setting temperature of the towed vehicle 200 through the user interface 240 before the towed vehicle 200 starts traveling.

For example, before the towed vehicle 200 starts traveling, the user may select a control intention (e.g., Yes) for the air conditioning system 230 of the towed vehicle 200 through USM (User Setting Mode) in a menu displayed on a display provided in the towing vehicle 100, and may input the interior setting temperature of the towed vehicle 200 therethrough.

The navigation device 250 outputs a modal dialog in the form of a vehicle destination input window when the control intention for the air conditioning system 230 of the towed vehicle 200 is input through the user interface 240.

The second vehicle controller 210 of the towed vehicle 200 transmits, when the user inputs the control intention for the air conditioning system 230 of the towed vehicle 200 and the interior setting temperature of the towed vehicle 200 through the user interface 240, a control signal for operating the air conditioning system 230 of the towed vehicle 200 to the air conditioning controller 220 of the towed vehicle 200. The air conditioning controller 220 of the towed vehicle 200 controls the operation of the air conditioning system 230 of the towed vehicle 200 based on the control signal received by the second vehicle controller 210.

For example, the second vehicle controller 210 transmits, when the user inputs the control intention for the air conditioning system 230 of the towed vehicle 200 and the interior setting temperature of the towed vehicle 200 through the user interface 240, an interior air recirculation mode command signal included in the control signal for operating the air conditioning system 230 to the air conditioning controller 220 before the towed vehicle starts traveling, in the flat tow mode in which the towing vehicle 100 is towing the towed vehicle 200 to the destination.

Accordingly, the air intake door of the air conditioning system 230 is switched to an interior air recirculation position for blocking outdoor air under the control of the air conditioning controller 220. Thus, it is possible to prevent exhaust gases, in the case of an internal combustion engine towing vehicle 100, from entering the interior of the towed vehicle 200, and to minimize energy consumption of an electric compressor that drives the air conditioning system 230 using the interior air recirculation mode when the air conditioning system 230 of the towed vehicle 200 is operated before arriving at the destination.

The navigation device 250 outputs, when a predetermined first specific time is left to reach the destination input through the destination input window while the towed vehicle 200 is traveling, an air conditioning system operation request signal for the towed vehicle 200 to the second vehicle controller 210.

In addition, the second vehicle controller 210 transmits a cooling or heating operation signal for the air conditioning system 230 to the air conditioning controller 220 based on the air conditioning operation request signal output from the navigation device 250.

Thus, the air conditioning controller 220 controls the cooling or heating operation of the air conditioning system 230 based on the cooling or heating operation signal for the air conditioning system 230 transmitted from the second vehicle controller 210.

For example, the air conditioning system 230 of the towed vehicle 200 is operated for interior cooling or heating by FATC (Full Automatic Temperature Control) of the air conditioning controller 220, so that the interior temperature and humidity of the towed vehicle 200 can be adjusted to a comfortable condition.

Further, the second vehicle controller 210 transmits an outdoor air recirculation mode command signal to the air conditioning controller 220 when a signal indicating that a second specific time, which is shorter than the first specific time, is left to reach the destination is received from the navigation device 250 during the heating operation of the air conditioning system 230.

When the second specific time, which is shorter than the first specific time, is left to reach the destination while the heating operation is performed by the air conditioning system 230, the transmission of the outdoor air recirculation mode command signal from the second vehicle controller 210 to the air conditioning controller 220 is performed to prevent frost or moisture from accumulating on a windshield glass of the towed vehicle 200. In other words, due to a difference between a vehicle interior temperature and a vehicle outdoor temperature, frost or moisture from accumulating on a windshield glass of the towed vehicle 200 may be prevented.

Thus, the intake door in the air conditioning system 230 is switched to an outdoor air recirculation position for drawing in outdoor air under the control of the air conditioning controller 220, so that the outdoor air may be introduced into the towed vehicle 200, thereby easily removing the frost or moisture accumulated on the windshield glass of the towed vehicle 200 by the outdoor air flowing in the interior before arriving at the destination.

Hereinafter, an air conditioning system control method for a towed vehicle according to another embodiment of the present disclosure is described.

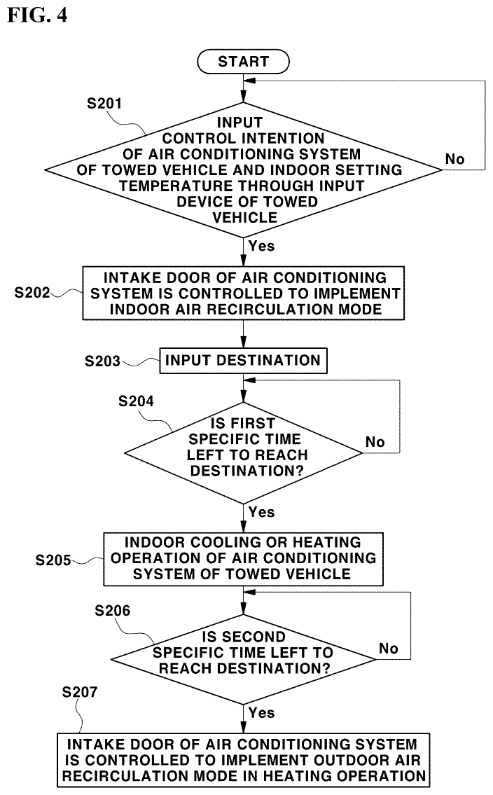

FIG. 4 is a flowchart showing an air conditioning control method for a towed vehicle according to another embodiment of the present disclosure.

First, it is determined whether a control intention of the air conditioning system 230 of the towed vehicle 200 and an interior setting temperature of the towed vehicle 200 are input through the input device 260 of the towed vehicle 200, by the second vehicle controller 210 of the towed vehicle 200 (S201).

Even when a user is a driver of a towing vehicle, the user enters the towed vehicle before departure to input the control intention of the air controlling system of the towed vehicle 200 and the interior setting temperature of the towed vehicle 200 through the input device 260 of the towed vehicle 200.

For example, before the towed vehicle 200 starts traveling, when the user selects the control intention (e.g., Yes) for the air conditioning system 230 of the towed vehicle 200 through the USM (User Setting Mode) in the display menu of the user interface 240 provided in the towed vehicle 200, and inputs the interior setting temperature of the towed vehicle 200, the second vehicle controller 210 may determine that the air conditioning system control intention and the interior setting temperature of the towed vehicle 200 are input.

Then, the intake door of the air conditioning system 230 is controlled to implement an interior air recirculation mode under the control of the air conditioning controller 220 of the towed vehicle 200 (S202).

To this end, when it is determined that the control intention for the air conditioning system 230 is input through the user interface 240, the second vehicle controller 210 transmits an interior air recirculation mode command signal to the air conditioning controller 220 before the towed vehicle 200 starts traveling.

Thus, the air intake door in the air conditioning system 230 is switched to the interior air recirculation position for blocking outdoor air under the control of the air conditioning controller 220. Thus, it is possible to prevent exhaust gases, in the case of an internal combustion engine towing vehicle 100, from entering the interior of the towed vehicle 200, and to minimize energy consumption of an electric compressor that drives the air conditioning system 230 using the interior air recirculation mode when the air conditioning system 230 of the towed vehicle 200 is operated before arriving at the destination.

Then, when the control intention for the air conditioning system 230 of the towed vehicle 200 is input through the user interface 240, the destination input window of the towed vehicle 200 is displayed in a modal dialog form on the navigation device 250, so that a destination of the towed vehicle may be input (S203).

Specifically, when the control intention signal for the air conditioning system 230 of the towed vehicle 200 input through the user interface 240 is transmitted to the navigation device 250, the navigation device 250 automatically outputs a modal dialog in the form of the towed vehicle destination input window, thereby allowing the user to input the towed vehicle's destination.

Thus, the user (driver) may input the towed vehicle's destination, and may move from the towed vehicle 200 to the towing vehicle 100 to tow the towed vehicle 200 while driving the towing vehicle 100 to the destination.

Then, the navigation device 250 determines whether a predetermined first specific time is left to reach the destination input through the destination input window during traveling (S204).

As a result of the determination in step S204, when it is determined that the first specific time is left to reach the destination of the towed vehicle 200, an operation request signal for the air conditioning system 230 of the towed vehicle 200 is output from the navigation device 250 to the second vehicle controller 210.

The first specific time may be determined to increase proportionally as a difference between the interior setting temperature and the current interior temperature of the towed vehicle 200 increases. Alternatively, the first specific time may be determined to decrease proportionally as the difference between the interior setting temperature and the current interior temperature of the towed vehicle 200 decreases.

Subsequently, based on the air conditioning system operation request signal output from the navigation device 250, the second vehicle controller 210 transmits a cooling or heating operation signal for the air conditioning system 230 to the air conditioning controller 220.

For example, depending on an outdoor temperature detected by a temperature sensor of the towed vehicle 200, the cooling operation signal for the air conditioning system 230 may be transmitted in extremely hot weather, and the heating operation signal for the air conditioning system 230 may be transmitted in extremely cold weather.

Accordingly, based on the cooling or heating operation signal for the air conditioning system 230 transmitted from the second vehicle controller 210, the air conditioning controller 220 performs control for operating the air conditioning system 230 in the interior cooling or interior heating mode, thereby performing the interior cooling or interior heating operation of the air conditioning system 230 of the towed vehicle 200 (S205).

For example, the air conditioning system 230 of the towed vehicle 200 is operated for interior cooling or heating by FATC (Full Automatic Temperature Control) of the air conditioning controller 220, so that the interior temperature and humidity of the towed vehicle 200 can be adjusted to a comfortable condition.

In this way, when the towing vehicle 100 tows the towed vehicle 200 to the destination, the air conditioning system 230 of the towed vehicle 200 is controlled to optimize the interior temperature and humidity of the towed vehicle 200 before reaching the destination. As a result, the air conditioning system 230 makes it possible to keep the interior of the towed vehicle 200 comfortable and improve the convenience of passengers entering the towed vehicle 200 after arriving at the destination.

Then, during the heating operation of the air conditioning system 230, it is determined whether the second specific time, which is shorter than the first specific time, is left to reach the destination through the navigation device 250 (S206).

When a signal indicating that the second specific time is left to reach the destination is received from the navigation device 250, the second vehicle controller 210 transmits an outdoor air recirculation mode command signal to the air conditioning controller 220.

The second specific time may be determined based on an increase or decrease rate of the first specific time. The second specific time may increase proportionally as the first specific time increases, and may decrease proportionally as the first specific time decreases.

Accordingly, the intake door of the air conditioning system 230 is switched to the outdoor air recirculation position for drawing in outdoor air under the control of the air conditioning controller 220 (S207).

In step S207, since it is unnecessary to switch the intake door to the outdoor air recirculation position due to a dehumidification effect in cooling, the intake door is switched to the outdoor air recirculation position during heating.

As described above, when the second specific time, which is shorter than the first specific time, is left to reach the destination, the intake door of the air conditioning system 230 of the towed vehicle 200 is switched to the outdoor air recirculation position before arriving at the destination, so that the outdoor air may be introduced into the towed vehicle 200. As a result, easily removing the frost or moisture accumulated on the windshield glass of the towed vehicle 200 by the outdoor air flowing in the interior of the towed vehicle 200 before arriving at the destination.

According to the present disclosure, when the towing vehicle 100 tows the towed vehicle 200 to the destination, the air conditioning system 230 of the towed vehicle 200 is controlled to optimize the interior temperature and humidity of the towed vehicle 200 before reaching the destination. As a result, it possible to keep the interior of the towed vehicle 200 comfortable and improve the convenience of passengers entering the towed vehicle 200 after reaching the destination.

The disclosure has been described in detail with reference to example embodiments thereof. However, it should be appreciated by those having ordinary skill in the art that changes may be made in these embodiments without departing from the principles and spirit of the disclosure, the scope of which is defined in the appended claims and their equivalents.

What is claimed is:

1. An air conditioning control system of a towed vehicle, the system comprising:
an input device of a towing vehicle configured to input a control intention of an air conditioning system of the towed vehicle and an interior setting temperature of the towed vehicle;
a first vehicle controller of the towing vehicle configured to transmit a control signal for operating the air conditioning system of the towed vehicle to the towed vehicle based on the control intention input via the input device;
a second vehicle controller of the towed vehicle that is configured to be communicably connected to the first vehicle controller and receive the control signal transmitted from the first vehicle controller; and
an air conditioning controller of the towed vehicle configured to control the operation of the air conditioning system of the towed vehicle based on the control signal received by the second vehicle controller.

2. The system according to claim 1, wherein the first vehicle controller transmits an interior air recirculation mode command signal included in the control signal for operating the air conditioning system to the air conditioning controller via the second vehicle controller before the towed vehicle starts traveling.

3. The system according to claim 1, wherein the input device comprises a user interface provided in the towed vehicle and a navigation device configured to output a destination input window of the towed vehicle when the control intention is input via the user interface.

4. The system according to claim 3, wherein the navigation device outputs an air conditioning system operation request signal for the towed vehicle to the first vehicle controller when a first specific time remains to reach a destination that is input via the destination input window while the towed vehicle is traveling.

5. The system according to claim 4, wherein the first vehicle controller transmits a cooling or heating operation signal for the air conditioning system to the air conditioning controller via the second vehicle controller based on the air conditioning system operation request signal output from the navigation device, and transmits an outdoor air recirculation mode command signal to the air conditioning controller via the second vehicle controller when a signal indicating that a second specific time remains to reach the destination is received from the navigation device during a heating operation of the air conditioning system, the second specific time is shorter than the first specific time.

6. An air conditioning control method for a towed vehicle, the method comprising:
inputting a control intention of an air conditioning system of the towed vehicle and an interior setting temperature of the towed vehicle via an input device of a towing vehicle;
transmitting a control signal for operating the air conditioning system of the towed vehicle from a first vehicle controller of the towing vehicle to a second vehicle controller of the towed vehicle based on the control intention input via the input device; and
controlling the air conditioning system of the towed vehicle by an air conditioning controller of the towed vehicle based on the control signal received by the second vehicle controller.

7. The method according to claim 6, wherein an interior air recirculation mode command signal included in the control signal for operating the air conditioning system is transmitted to the air conditioning controller via the second vehicle controller from the first vehicle controller before the towed vehicle starts traveling, and
wherein an intake door in the air conditioning system of the towed vehicle is switched to an interior air recirculation mode via the control of the air conditioning controller.

8. The method according to claim 6, further comprising:
outputting a destination input window of the towed vehicle on a navigation device when the control intention is input via the input device;
outputting an air conditioning system operation request signal for the towed vehicle from the navigation device to the first vehicle controller when a first specific time remains to reach a destination that is input via the destination input window; and
transmitting a cooling or heating operation signal for the air conditioning system to the air conditioning controller via the second vehicle controller from the first vehicle controller based on the air conditioning system operation request signal output from the navigation device.

9. The method according to claim 8, wherein the air conditioning system of the towed vehicle is operated for interior cooling or heating by FATC (Full Automatic Temperature Control) of the air conditioning controller.

10. The method according to claim 8, further comprising:
transmitting an outdoor air recirculation mode command signal to the air conditioning controller via the second vehicle controller when the first vehicle controller receives a signal indicating that a second specific time remains to reach the destination from the navigation device, the second specific time is shorter than the first specific time; and
switching an intake door in the air conditioning system of the towed vehicle to an interior air recirculation mode via the control of the air conditioning controller.

11. The method according to claim 10, wherein the first specific time increases as a difference between the interior setting temperature and a current interior temperature of the towed vehicle increases, and wherein the second specific time is determined based on an increase or decrease rate of the first specific time.

12. An air conditioning control system of a towed vehicle, the system comprising:
an input device of the towed vehicle configured to input a control intention of an air conditioning system of the towed vehicle and an interior setting temperature of the towed vehicle, in a flat tow mode;
a second vehicle controller of the towed vehicle configured to transmit a control signal for operating the air conditioning system of the towed vehicle to an air conditioning controller of the towed vehicle based on the control intention input via the input device; and
the air conditioning controller of the towed vehicle configured to control the operation of the air conditioning system of the towed vehicle based on the control signal received by the second vehicle controller,
wherein the second vehicle controller transmits an interior air recirculation mode command signal included in the control signal for operating the air conditioning system to the air conditioning controller before the towed vehicle starts traveling.

13. The system according to claim 12, wherein the input device comprises a user interface provided in the towed vehicle and a navigation device configured to output a destination input window of the towed vehicle when the control intention is input via the user interface.

14. The system according to claim 13, wherein the navigation device outputs an air conditioning system operation request signal for the towed vehicle to the second vehicle controller when a first specific time remains to reach a destination that is input via the destination input window while the towed vehicle is towed by the towing vehicle.

15. The system according to claim 14, wherein the second vehicle controller transmits a cooling or heating operation signal for the air conditioning system to the air conditioning controller based on the air conditioning system operation request signal output from the navigation device, and transmits an outdoor air recirculation mode command signal to the air conditioning controller when a signal indicating that a second specific time remains to reach the destination is received from the navigation device during a heating operation of the air conditioning system, the second specific time is shorter than the first specific time.

16. An air conditioning control method for a towed vehicle, the method comprising:
inputting a control intention of an air conditioning system of the towed vehicle and an interior setting temperature of the towed vehicle via an input device of the towed vehicle;
transmitting a control signal for operating the air conditioning system of the towed vehicle to an air conditioning controller of the towed vehicle based on the control intention input via the input device; and
controlling the air conditioning system of the towed vehicle by the air conditioning controller of the towed vehicle based on the control signal received from a second vehicle controller,
wherein an interior air recirculation mode command signal included in the control signal for operating the air conditioning system is transmitted to the air conditioning controller from the second vehicle controller before the towed vehicle starts traveling, and
wherein an intake door in the air conditioning system of the towed vehicle is switched to an interior air recirculation mode via the control of the air conditioning controller.

17. The method according to claim 16, further comprising:
outputting a destination input window of the towed vehicle on a navigation device when the control intention is input via the input device of the towed vehicle;
outputting an air conditioning system operation request signal for the towed vehicle from the navigation device to the second vehicle controller when a first specific time remains to reach a destination that is input via the destination input window; and
transmitting a cooling or heating operation signal for the air conditioning system to the air conditioning controller from the second vehicle controller based on the air conditioning system operation request signal output from the navigation device.

18. The method according to claim 17, wherein the air conditioning system of the towed vehicle is operated for interior cooling or heating by FATC (Full Automatic Temperature Control) of the air conditioning controller.

19. The method according to claim 17, further comprising:
transmitting, while a heating operation of the air conditioning system is performed, an outdoor air recirculation mode command signal to the air conditioning controller when the second vehicle controller receives a signal indicating that a second specific time remains to reach the destination from the navigation device, the second specific time is shorter than the first specific time; and
switching the intake door in the air conditioning system of the towed vehicle to an outdoor air recirculation mode via the control of the air conditioning controller.

20. The method according to claim 19, wherein the first specific time increases as a difference between the interior setting temperature and a current interior temperature of the towed vehicle increases, and wherein the second specific time is determined based on an increase or decrease rate of the first specific time.
